(19) United States
(12) Patent Application Publication
(10) Pub. No.: US 2026/0003108 A1
(43) Pub. Date: Jan. 1, 2026

(54) OPTICAL MEMBER AND DISPLAY APPARATUS INCLUDING THE SAME

(71) Applicant: SAMSUNG SDI CO., LTD., Yongin-si (KR)

(72) Inventors: Dong Heon YUN, Suwon-si (KR); Tae Ji KIM, Suwon-si (KR); Irina NAM, Suwon-si (KR); Won KIM, Suwon-si (KR); Il Jin KIM, Suwon-si (KR)

(21) Appl. No.: 19/251,979

(22) Filed: Jun. 27, 2025

(30) Foreign Application Priority Data
Jun. 29, 2024 (KR) 10-2024-0085858

(51) Int. Cl. G02B 5/00

(52) U.S. Cl. CPC G02B 5/003

(57) ABSTRACT

An optical member includes a first transmittance control layer, the first transmittance control layer including a dye having a maximum absorption wavelength of 570 nm to 610 nm, a second transmittance control layer, the second transmittance control layer including a mixture of a first dye having a maximum absorption wavelength of 400 nm to 440 nm, a second dye having a maximum absorption wavelength of 480 nm to 520 nm, and a third dye having a maximum absorption wavelength of 650 nm to 700 nm, and a base film, the second transmittance control layer being between the base film and the first transmittance control layer.

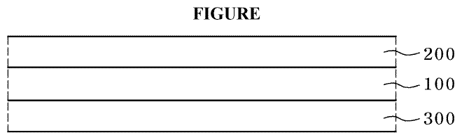

### CROSS-REFERENCE TO RELATED APPLICATION

The present application claims priority and the benefit of Korean Patent Application No. 10-2024-0085858, filed on Jun. 29, 2024, in the Korean Intellectual Property Office, the entire disclosure of which is incorporated herein by reference.

### 1. FIELD

The present disclosure relates to an optical member and a display apparatus including the same.

### 2. DESCRIPTION OF THE RELATED ART

Light emitting displays, including organic light emitting displays and the like, do not require a polarizing plate. However, such a light emitting display can have poor screen quality due to total reflection of external light at a surface of a panel therein. Therefore, the light emitting displays may include a polarizing plate on an upper surface of the panel therein. The polarizing plate may include a polarizer, a retardation film, and a UV absorber to prevent damage to a light emitting device due to external light.

### SUMMARY

It is an aspect of the present disclose to provide an optical member including a first transmittance control layer, a second transmittance control layer, and a base film stacked sequentially, wherein the first transmittance control layer includes a dye having a maximum absorption wavelength of 570 nm to 610 nm, and the second transmittance control layer includes a mixture of a dye having a maximum absorption wavelength of 400 nm to 440 nm, a dye having a maximum absorption wavelength of 480 nm to 520 nm, and a dye having a maximum absorption wavelength of 650 nm to 700 nm.

In embodiments, the dye in the first transmittance control layer may have a maximum absorption wavelength of 570 nm to 580 nm.

In embodiments, the dye having the maximum absorption wavelength of 570 nm to 610 nm may be present in an amount of 90 wt % or more based on a total weight of all dyes in the first transmittance control layer.

In embodiments, the second transmittance control layer may include 80 wt % or more of the mixture of the first dye, the second dye, and the third dye, based on a total weight of all dyes in the second transmittance control layer.

In embodiments, the second transmittance control layer may further include a fourth dye having a maximum absorption wavelength of 570 nm to 610 nm.

In embodiments, in the second transmittance control layer, the fourth dye may include at least one of a dye having a maximum absorption wavelength of greater than 580 nm and less than or equal to 590 nm, a dye having a maximum absorption wavelength of greater than 590 nm and less than or equal to 600 nm, and a dye having a maximum absorption wavelength of greater than 600 nm and less than or equal to 610 nm.

In embodiments, the second transmittance control layer may include 90 wt % or more of a mixture of the first dye, the second dye, the third dye, and the fourth dye, based on a total weight of all dyes in the second transmittance control layer.

In embodiments, the fourth dye in the second transmittance control layer may include at least one of a sub-PC dye or a porphyrin dye.

In embodiments, the dye in the first transmittance control layer may include at least one of a sub-PC dye or a porphyrin dye.

In embodiments, the first dye in the second transmittance control layer may include a porphyrin dye.

In embodiments, the second dye in the second transmittance control layer may include at least one of an azo dye, a perylene dye, or a xanthene dye.

In embodiments, the third dye in the second transmittance control layer may include at least one of a squaraine dye or a cyanine dye.

In embodiments, the first transmittance control layer may further include a UV absorber.

In embodiments, the first transmittance control layer may further include a base resin.

In embodiments, the second transmittance control layer may further include a base resin.

It is another aspect of the present disclose to provide an optical display apparatus including the above optical member.

In embodiments, the optical display apparatus may be free from a polarizer.

### BRIEF DESCRIPTION OF THE DRAWINGS

Features will become apparent to those of skill in the art by describing in detail exemplary embodiments with reference to the attached drawings, in which:

FIGURE is a cross-sectional view of an optical member according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURES, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

Herein, the singular forms “a”, “an”, and “the” are intended to include the plural forms as well, unless the context specifically indicates otherwise.

Herein, “homopolymer glass transition temperature” may refer to a glass transition temperature (Tg) measured on a homopolymer of a target monomer using a differential scanning calorimeter (Discovery, TA Instruments Inc.). Specifically, the homopolymer of the target monomer is heated to 180° C. at a heating rate of 20° C./min, cooled gradually to −100° C., and heated to 100° C. at a heating rate of 10° C./min to obtain data on an endothermic transition curve, followed by determining the glass transition temperature by an inflection point of the endothermic transition curve.

Herein, “light transmittance” refers to total luminous transmittance.

Herein, “light emitting device” includes an organic or organic/inorganic hybrid light emitting device and may refer to a device including a light emitting diode (LED), an organic light emitting diode (OLED), a quantum dot light emitting diode (QLED), a light emitting material, such as a phosphor, or the like.

Herein, “(meth)acryl” refers to acryl and/or methacryl.

Herein, “maximum absorption wavelength” refers to a wavelength at which a maximum absorbance appears in measurement of absorbance of a dye solution in which a dye is dissolved at a concentration of 10 ppm in methyl ethyl ketone. The absorbance may be measured by a typical method known in the art.

As used herein to represent a specific numerical range, the expression “X to Y” means “greater than or equal to X and less than or equal to Y (X≤ and ≤Y)”.

In accordance with one aspect of the present disclosure, an optical member is provided. The optical member may be used in an optical display apparatus without a polarizing plate including a polarizer, e.g., a light emitting device display without a polarizing plate.

According to an embodiment, the optical member has a low light transmittance variation at a wavelength of 400 nm to 700 nm even after long-term exposure to UV light under repeated cycles of temperature change between room temperature and high temperature. This indicates that the optical member has high resistance to light and thus can prevent damage to a light emitting device due to external light even after long-term exposure to UV light under repeated cycles of temperature change between room temperature and high temperature.

In this regard, the optical member has a maximum light transmittance variation ΔT(max) of 5% or less among light transmittance variations ΔT(λ), as calculated according to the following Equation 1. Within this range, the optical member can improve lifespan of a light emitting device display by reducing damage to a light emitting device even after long-term exposure to UV light under repeated cycles of temperature change between room temperature and high temperature.

$$Δ T ( λ ) = \vert {T}_{2} ( λ ) - {T}_{1} ( λ ) \vert , \qquad Equation ( 1 )$$

In Equation 1, above, T₁(λ) is a light transmittance (unit: %) of the optical member at a wavelength λ (nm) in the range of 400 nm to 700 nm and T₂(λ) is a light transmittance (unit: %) of the optical member at a wavelength λ (nm) in the range of 400 nm to 700 nm, as measured after a total of 10 cycles of light irradiation, wherein one cycle is defined as irradiating the optical member with 340 nm light at an irradiance of 0.35 W/m² while leaving the optical member at 25° C. for 4 hours and at 63° C. for 8 hours.

In an embodiment, the optical member may have transmitted color coordinate values of −5≤a*≤5 and −13≤b*≤5, wherein a* and b* are transmitted/reflected color values.

In an embodiment, the optical member may have a light transmittance of 55% or more at a wavelength of 458 nm, which corresponds to blue light. In an embodiment, the optical member may have a light transmittance of 40% or more at a wavelength of 530 nm, which corresponds to green light. In an embodiment, the optical member may have a light transmittance of 40% or more at a wavelength of 630 nm, which corresponds to red light.

In an embodiment, in the optical member, a difference between light transmittance at a wavelength of 504 nm and light transmittance at a wavelength of 494 nm may be 10% or less. In an embodiment, in the optical member, a difference between light transmittance at a wavelength of 594 nm and light transmittance at a wavelength of 583 nm may be 5% or less.

Hereinafter, an optical member according to an embodiment will be described. The optical member may include a first transmittance control layer, a second transmittance control layer, and a base film stacked sequentially (e.g., the second transmittance control layer may be stacked between the base film and the first transmittance control layer). The first transmittance control layer may include a dye having a maximum absorption wavelength of 570 nm to 610 nm, and the second transmittance control layer may include a mixture of a first dye having a maximum absorption wavelength of 400 nm to 440 nm, a second dye having a maximum absorption wavelength of 480 nm to 520 nm, and a third dye having a maximum absorption wavelength of 650 nm to 700 nm.

The optical member may be adhesively attached to a panel for optical display apparatuses, with the first transmittance control layer, the second transmittance control layer, and the base film sequentially stacked on the panel (e.g., the first transmittance control layer may be positioned to face the panel). Accordingly, external light may sequentially pass through the base film, the second transmittance control layer, and the first transmittance control layer. Through incorporation of the dye having a maximum absorption wavelength of 570 nm to 610 nm, e.g., 570 nm 580 nm, into the first transmittance control layer, the optical member may have a significantly improved resistance to light.

In the following, each component of the optical member will be described in detail.

### Transmittance Control Layer

### (1) First Transmittance Control Layer

The first transmittance control layer may include a dye having a maximum absorption wavelength of 570 nm to 610 nm. When used in the optical member, the dye having a maximum absorption wavelength of 570 nm to 610 nm can absorb mixed colors and enhance color reproduction while minimizing loss of luminance.

The dye having a maximum absorption wavelength of 570 nm to 610 nm may include at least one of a sub-PC dye or a porphyrin dye. Sub-PC and porphyrin dyes tend to decompose easily under light resistance testing, thus increasing the light transmittance variation of an optical member. Conversely, through incorporation of at least one of a sub-PC dye or a porphyrin dye into the first transmittance control layer, the optical member according to the present disclosure may have improved resistance to light.

According to an embodiment, the dye having a maximum absorption wavelength of 570 nm to 610 nm may have a maximum absorption wavelength of 570 nm to 580 nm, e.g., 575 nm to 580 nm.

According to an embodiment, the sub-PC dye or the porphyrin dye may have a full-width at half maximum of 10 nm to 100 nm, e.g., 50 nm to 100 nm.

According to an embodiment, the dye having a maximum absorption wavelength of 570 nm to 610 nm may be in an amount of 0.1 parts by weight to 5 parts by weight, e.g., 0.1 parts by weight to 3 parts by weight, 0.1 parts by weight to 2 parts by weight, 1 part by weight to 2 parts by weight, or 0.5 part by weight to 2 parts by weight relative to 100 parts by weight of a base resin described below. Within this range, the optical member may easily provide the aforementioned effects.

According to an embodiment, the dye having a maximum absorption wavelength of between 570 nm to 610 nm may be present in an amount of 90 wt % or more, e.g., 90 wt % to 100 wt %, 95 wt % to 100 wt %, or 100 wt %, based on the total weight of all dyes contained in the first transmittance control layer. Within this rage, the aforementioned effects of the optical member described above can be further improved.

The first transmittance control layer may further include the base resin as a matrix for formation of the first transmittance control layer. The base resin may include at least one of a curable resin or a non-curable resin.

The curable resin may include a resin that is cured by heat and/or light to form the matrix of the first transmittance control layer. For example, the curable resin may include a (meth)acrylic resin, an epoxy resin, a silicone resin, and the like. For example, the curable resin includes a (meth)acrylic resin in consideration of compatibility with dyes, ease of preparation, and the like. The following description will focus on the (meth)acrylic resin. However, any suitable curable resin may be implemented.

The (meth)acrylic resin may have a glass transition temperature of 40° C. to 200° C. Within this range, the first transmittance control layer can satisfy requirements related to glass transition temperature and indentation modulus, can exhibit reduced brittleness, and can have good adhesion to an antireflection film and/or an adhesive layer described below.

The (meth)acrylic resin may have a weight average molecular weight of 10,000 g/mol to 100,000 g/mol, e.g., 10,000 g/mol to 50,000 g/mol. Within this range, formation of the first transmittance control layer may be facilitated.

The (meth)acrylic resin may include a (meth)acrylic copolymer of a monomer mixture including 35 wt % or more of a (meth)acrylic monomer having a homopolymer glass transition temperature of 50° C. to 120° C. in the monomer mixture, based on a total amount of the monomer mixture. This feature can make it easy to ensure that the first transmittance control layer satisfies requirements related to glass transition temperature and indentation modulus. For example, the (meth)acrylic monomer having a homopolymer glass transition temperature of 50° C. to 120° C. may be present in an amount of 35 wt % to 99 wt % in the monomer mixture, based on a total amount of the monomer mixture. Within this range, the transmittance control layer can satisfy requirements related to glass transition temperature and indentation modulus and can have good adhesion to an antireflection film and/or an adhesive layer described below.

In an embodiment, the (meth)acrylic monomer having a homopolymer glass transition temperature of 50° C. to 120° C. may include at least one selected from among methyl methacrylate, ethyl methacrylate, t-butyl methacrylate, and isobornyl methacrylate.

The (meth)acrylic resin may include a (meth)acrylic copolymer of a monomer mixture including 65 wt % or less of a (meth)acrylic monomer having a homopolymer glass transition temperature of −70° C. to 0° C. This feature ensures that the first transmittance control layer can have high resistance to brittleness. For example, the (meth)acrylic monomer having a homopolymer glass transition temperature of −70° C. to 0° C. may be present in an amount of 1 wt % to 65 wt % in the monomer mixture, based on a total amount of the monomer mixture. The (meth)acrylic monomer having a homopolymer glass transition temperature of −70° C. to 0° C., e.g., a homopolymer glass transition temperature of −70° C. to −10° C.

In an embodiment, the (meth)acrylic monomer having a homopolymer glass transition temperature of −70° C. to 0° C. may include at least one selected from among n-butyl acrylate, ethyl acrylate, 2-ethylhexyl acrylate, and 2-hydroxyethyl acrylate.

The (meth)acrylic resin may include a copolymer (e.g., a random copolymer) of a monomer mixture including an alkyl group-containing (meth)acrylic monomer; a hydroxyl group-containing (meth)acrylic monomer; and at least one of an aromatic group-containing (meth)acrylic monomer, a cycloaliphatic group-containing (meth)acrylic monomer, or a hetero-cycloaliphatic group-containing (meth)acrylic monomer.

The alkyl group-containing (meth)acrylic monomer may include a (meth)acrylic acid ester containing an unsubstituted C₁ to C₁₀ alkyl group. For example, the alkyl group-containing (meth)acrylic monomer may include at least one selected from among methyl (meth)acrylate, ethyl (meth)acrylate, propyl (meth)acrylate, n-butyl (meth)acrylate, t-butyl (meth)acrylate, isobutyl (meth)acrylate, and pentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, and decyl (meth)acrylate. These may be used alone or as a mixture thereof. The alkyl group-containing (meth)acrylic monomer may be present in an amount of 60 wt % to 99 wt %, e.g., 60 wt % to 90 wt %, in the monomer mixture, based on a total amount of the monomer mixture. Within this range, the desired effects of the present disclosure can be well achieved.

The hydroxyl group-containing (meth)acrylic monomer may include at least one selected from among a (meth)acrylic monomer containing a C₁ to C₂₀ alkyl group having one or more hydroxyl groups, a (meth)acrylic monomer containing a C₃ to C₂₀ cycloalkyl group having one or more hydroxyl groups, and a (meth)acrylic monomer containing a C₆ to C₂₀ aromatic group having one or more hydroxyl groups. For example, the hydroxyl group-containing (meth)acrylic monomer includes a (meth)acrylic monomer containing a C₁ to C₂₀ alkyl group having one or more hydroxyl groups, e.g., at least one selected from among 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 1-chloro-2-hydroxypropyl (meth)acrylate. These may be used alone or as a mixture thereof. The hydroxyl group-containing (meth)acrylic monomer may be present in an amount of 0.01 wt % to 20 wt %, e.g., 0.1 wt % to 10 wt %, in the monomer mixture, based on a total amount of the monomer mixture.

The aromatic group-containing (meth)acrylic monomer may include a (meth)acrylic acid ester containing a C₆ to C₂₀ aryl group or a C₇ to C₂₀ arylalkyl group. For example, the aromatic group-containing (meth)acrylic monomer may include phenyl (meth)acrylate, benzyl (meth)acrylate, and the like. The aromatic group-containing (meth)acrylic monomer may be present in an amount of 50 wt % or less, e.g., 20 wt % or less, based on a total amount of the monomer mixture.

Herein, monomers containing a mixture of a cycloaliphatic group and an alkyl group are classified as the cycloaliphatic group-containing (meth)acrylic monomer. The cycloaliphatic group-containing (meth)acrylic monomer may include a (meth)acrylic acid ester containing a C₅ to C₂₀ monocyclic or heterocyclic cycloaliphatic group, e.g., at least one selected from among cyclohexyl (meth)acrylate, isobornyl (meth)acrylate, dicyclopentanyl (meth)acrylate, methylcyclohexyl (meth)acrylate, and dicyclopentenyl (meth)acrylate. The cycloaliphatic group-containing (meth)acrylic monomer may be present in an amount of 0.1 wt % to 35 wt %, e.g., 1 wt % to 35 wt % or 5 wt % to 35 wt %, in the monomer mixture, based on a total amount of the monomer mixture.

The hetero-cycloaliphatic group-containing (meth)acrylic monomer may include a (meth)acrylic acid ester having a C₄ to C₉ hetero-cycloaliphatic group containing at least one of nitrogen, oxygen, or sulfur. For example, the hetero-cycloaliphatic group-containing (meth)acrylic monomer may include (meth)acryloylmorpholine. The hetero-cycloaliphatic group-containing (meth)acrylic monomer may be present in an amount of 50 wt % or less, e.g., 10 wt % or less, in the monomer mixture, based on a total amount of the monomer mixture.

For example, the (meth)acrylic resin may include a copolymer of a monomer mixture including 60 wt % to 99 wt %, e.g., 60 wt % to 90 wt %, of the alkyl group-containing (meth)acrylic monomer, 0.01 wt % to 20 wt %, e.g., 0.1 wt % to 10 wt %, of the hydroxyl group-containing (meth)acrylic monomer, and 0.1 wt % to 35 wt %, e.g., 1 wt % to 35 wt %, of the cycloaliphatic group-containing (meth)acrylic monomer.

A composition for the first transmittance control layer may further include a crosslinking agent in addition to the (meth)acrylic resin. The crosslinking agent crosslinks the (meth)acrylic resin and may include any suitable crosslinking agent. The crosslinking agent may include at least one selected from among, e.g., isocyanate, epoxy, metal chelate, amine, and aziridine crosslinking agents. For example, the crosslinking agent may include an isocyanate crosslinking agent. The isocyanate crosslinking agent may include, e.g., hexamethylene diisocyanate (HDI), toluene diisocyanate (TDI) including 2,4-toluene diisocyanate, 2,6-toluene diisocyanate, and the like, 4,4′-methylenediphenyl diisocyanate (MDI), xylylene diisocyanate (XDI) including 1,3-xylylene diisocyanate, 1,4-xylylene diisocyanate, and the like, hydrogenated toluene diisocyanate; isophorone diisocyanate; 1,3-bisisocyanatomethylcyclohexane, tetramethylxylene diisocyanate, 1,5-naphthalene diisocyanate, 2,2,4-trimethylhexamethylene diisocyanate, 2,4,4-trimethylhexamethylene diisocyanate, a trimethylolpropane/toluene diisocyanate adduct including a trimer adduct of trimethylolpropane/toluene diisocyanate and the like, a xylylene diisocyanate adduct of trimethylolpropane, triphenylmethane triisocyanate, methylene bis (triisocyanate), and the like.

The crosslinking agent may be present in an amount of 0.01 parts by weight to 20 parts by weight, e.g., 0.01 parts by weight to 10 parts by weight or 0.1 parts by weight to 4 parts by weight, relative to 100 parts by weight of the (meth)acrylic resin. Within this range, the composition can be crosslinked to form the first transmittance control layer without reduction in transparency due to excessive use of the crosslinking agent.

The non-curable resin may include a resin free from a functional group that is reactive to heat and/or light, e.g., a (meth)acrylic group, a hydroxyl group, an epoxy group, a carboxylic acid group, and the like. The non-curable resin may include a resin that is prepared by solvent casting without a crosslinking agent and an initiator and can form the matrix of the first transmittance control layer.

The non-curable resin may have a glass transition temperature of 40° C. to 200° C. Within this range, the first transmittance control layer according to the present disclosure may satisfy a requirement related to glass transition temperature and can exhibit reduced brittleness. For example, the non-curable resin has a glass transition temperature of 100° C. to 200° C.

The non-curable resin may include at least one selected from among, e.g., a poly (methyl methacrylate) (PMMA) resin, a cyclic olefin polymer (COP) resin, a polycarbonate resin, a modified polycarbonate resin, a polyester resin, and a polystyrene resin. For example, the non-curable resin includes at least one selected from among a cyclic olefin polymer resin, a polycarbonate resin, and a modified polycarbonate resin.

The first transmittance control layer may further include a UV absorber. The UV absorber may be present in an amount of 0.1 parts by weight to 5 parts by weight, e.g., 0.1 parts by weight to 3 parts by weight or 1 part by weight to 2 parts by weight, relative to 100 parts by weight of the base resin. The UV absorber may include an indole UV absorber.

The composition for the first transmittance control layer may further include an additive, e.g., at least one of a silane coupling agent, an antioxidant, a tackifier resin, a plasticizer, an antistatic agent, a reworking agent, and the like.

The silane coupling agent may provide better adhesion to an adherend. The silane coupling agent may include any suitable silane coupling agent. For example, the silane coupling agent may include at least one of silicon compounds having an epoxy structure, such as 3-glycidoxypropyltrimethoxysilane, 3-glycidoxypropylmethyldimethoxysilane, 2-(3,4-epoxycyclohexyl)ethyltrimethoxysilane, and the like; polymerizable unsaturated group-containing silicon compounds, such as vinyltrimethoxysilane, vinyltriethoxysilane, (meth)acryloxypropyltrimethoxysilane, and the like; amino group-containing silicon compounds, such as 3-aminopropyltrimethoxysilane, N-(2-aminoethyl)-3-aminopropyltrimethoxysilane, N-(2-aminoethyl)-3-aminopropylmethyldimethoxysilane, and the like; and 3-chloropropyltrimethoxysilane.

The additives may be present in an amount of 0.001 parts by weight to 5 parts by weight, e.g., 0.01 parts by weight to 1 part by weight, relative to 100 parts by weight of the curable resin or the non-curable resin. Within this range, the additives can provide intended effects without affecting the properties of the transmittance control layer.

For example, the composition for the first transmittance control layer may be free from a solvent. In another example, the composition for the first transmittance control layer may further include a solvent. Incorporation of a solvent into the composition for the first transmittance control layer allows reduction in thickness of the first transmittance control layer while improving coatability of the composition. For example, the solvent may include any suitable solvent, e.g., at least one selected from among methyl ethyl ketone, ethyl acetate, and toluene.

The first transmittance control layer may be formed by depositing the composition to a predetermined thickness on a base film or a release film, followed by drying the solvent. When the composition for the first transmittance control layer includes the curable resin, the composition may be further subjected to thermal curing or photocuring. Here, thermal curing may include not only curing through heat treatment at 40° C. to 100° C., but also curing at room temperature (e.g., 20° C. to 30° C.).

The first transmittance control layer may have a thickness of 1 μm to 50 μm, e.g., 1 μm to 25 μm, 1 μm to 10 μm, or 1 μm to 5 μm.

### (2) Second Transmittance Control Layer

The second transmittance control layer may include a mixture of a first dye having a maximum absorption wavelength of 400 nm to 440 nm, a second dye having a maximum absorption wavelength of 480 nm to 520 nm, and a third dye having a maximum absorption wavelength of 650 nm to 700 nm. The second transmittance control layer may further include a fourth dye having a maximum absorption wavelength of 570 nm to 610 nm.

When used in the optical member, the first dye having a maximum absorption wavelength of 400 nm to 440 nm may enhance color value b* of the optical member. In an embodiment, the first dye having a maximum absorption wavelength of 400 nm to 440 nm may be present in an amount of 0.5 parts by weight to 5 parts by weight, e.g., 0.5 parts by weight to 2 parts by weight, relative to 100 parts by weight of the base resin. Within this range, the optical member can easily provide the aforementioned effects.

The first dye having a maximum absorption wavelength of 400 nm to 440 nm may include one or more dyes having a maximum absorption wavelength in this range. For example, the first dye having a maximum absorption wavelength of 400 nm to 440 nm may include at least one of a dye having a maximum absorption wavelength of 400 nm to 430 nm or a dye having a maximum absorption wavelength of greater than 430 nm and less than or equal to 440 nm.

According to an embodiment, the first dye having a maximum absorption wavelength of 400 nm and 440 nm may have a full-width at half maximum of 10 nm to 40 nm. According to an embodiment, the first dye having a maximum absorption wavelength of 400 nm to 440 nm may include a porphyrin dye.

According to an embodiment, the first dye of the second transmittance control layer may include a dye having a maximum absorption wavelength of 400 nm to 430 nm. The dye having a maximum absorption wavelength of 400 nm to 430 nm may be present in an amount of 2 parts by weight or less, e.g., 0.01 parts by weight to 2 parts by weight or 0.01 parts by weight to 1.5 parts by weight, relative to 100 parts by weight of a base resin described below. The dye having a maximum absorption wavelength of 400 nm to 430 nm may include a porphyrin dye.

According to an embodiment, the first dye of the second transmittance control layer may include a dye having a maximum absorption wavelength of greater than 430 nm and less than or equal to 440 nm. The dye having a maximum absorption wavelength of greater than 430 nm and less than or equal to 440 nm may be present in an amount of 0.1 parts by weight to 2 parts by weight, e.g., 1 part by weight to 2 parts by weight, relative to 100 parts by weight of the base resin described below. The dye having a maximum absorption wavelength of greater than 430 nm and less than or equal to 440 nm may include a porphyrin dye.

When used in the optical member, the second dye having a maximum absorption wavelength of 480 nm to 520 nm may reduce reflectance of the optical member. In an embodiment, the second dye having a maximum absorption wavelength of 480 nm to 520 nm may be present in an amount of 0.5 parts by weight to 5 parts by weight, e.g., 0.5 parts by weight to 2 parts by weight, relative to the 100 parts by weight of the base resin. Within this range, the optical member may easily provide the aforementioned effects.

The second dye having a maximum absorption wavelength of 480 nm to 520 nm may include one or more dyes having a maximum absorption wavelength in this range. According to an embodiment, the second dye having a maximum absorption wavelength of 480 nm to 520 nm may include at least one of a dye having a maximum absorption wavelength of 480 nm to 500 nm or a dye having a maximum absorption wavelength of greater than 500 nm and less than or equal to 520 nm.

According to an embodiment, the second dye having a maximum absorption wavelength of 480 nm to 520 nm may have a full-width at half maximum of 10 nm to 40 nm. According to an embodiment, the second dye having a maximum absorption wavelength of 480 nm to 520 nm may include at least one of an azo dye, a perylene dye, or a xanthene dye.

According to an embodiment, the second dye in the second transmittance control layer may include a dye having a maximum absorption wavelength of 480 nm to 500 nm. The dye having a maximum absorption wavelength of 480 nm to 500 nm may be present in an amount of 0.1 parts by weight to 3 parts by weight, e.g., 0.1 parts by weight to 2 parts by weight or 0.1 parts by weight to 1 part by weight, relative to 100 parts by weight of the base resin described below. The dye having a maximum absorption wavelength of 480 nm to 500 nm may include an azo dye or a perylene dye.

According to an embodiment, the second dye in the second transmittance control layer may include a dye having a maximum absorption wavelength of greater than 500 nm and less than or equal to 520 nm. The dye having a maximum absorption wavelength of greater than 500 nm and less than or equal to 520 nm may be present in an amount of 0.1 parts by weight to 3 parts by weight, e.g., 0.1 parts by weight to 2 parts by weight or 0.5 parts by weight to 1.5 parts by weight, relative to 100 parts by weight of the base resin described below. The dye having a maximum absorption wavelength of greater than 500 nm and less than or equal to 520 nm may include a xanthene dye.

When used in the optical member, the third dye having a maximum absorption wavelength of 650 nm to 700 nm can reduce reflected color value a* of the optical member, thereby improving visibility of a panel for optical display apparatuses.

In an embodiment, the third dye having a maximum absorption wavelength of 650 nm to 700 nm may be present in an amount of 0.1 parts by weight to 5 parts by weight, e.g., 0.5 parts by weight to 5 parts by weight, 0.5 parts by weight to 2 parts by weight, 0.1 parts by weight to 3 parts by weight, e.g., 0.1 parts by weight to 2 parts by weight or 0.5 parts by weight to 1.5 parts by weight, relative to the 100 parts by weight of the base resin. Within this range, the optical member can easily provide the aforementioned effects.

For example, the third dye having a maximum absorption wavelength of 650 nm to 700 nm may have a maximum absorption wavelength of 660 nm to 690 nm, e.g., 660 nm to 680 nm. The third dye having a maximum absorption wavelength of 650 nm to 700 nm may include a squaraine dye or a cyanine dye.

In an embodiment, the third dye having a maximum absorption wavelength of 650 nm to 700 nm may have a full-width at half maximum of 10 nm to 40 nm.

In an embodiment, the third dye in the second transmittance control layer may include 80 wt % or more, e.g., 80 wt to 100 wt %, of a mixture of the first dye having a maximum absorption wavelength of 400 nm to 440 nm, the second dye having a maximum absorption wavelength of 480 nm to 520 nm, and the third dye having a maximum absorption wavelength of 650 nm to 700 nm, based on the total weight of all dyes contained in the second transmittance control layer.

The second transmittance control layer may further include a fourth dye having a maximum absorption wavelength of 570 nm to 610 nm. In an embodiment, the fourth dye having a maximum absorption wavelength of 570 nm to 610 nm may be present in an amount of 0.5 parts by weight to 5 parts by weight, e.g., 1 part by weight to 5 parts by weight, relative to 100 parts by weight of the base resin. Within this range, the optical member can easily provide the aforementioned effects.

According to an embodiment, the fourth dye having a maximum absorption wavelength of 570 nm to 610 nm may have a full-width at half maximum of 10 nm to 100 nm. According to an embodiment, the fourth dye having a maximum absorption wavelength of 570 nm to 610 nm may include at least one of a sub-PC dye or a porphyrin dye.

According to an embodiment, the second transmittance control layer may further include at least one of a dye having a maximum absorption wavelength of greater than 580 nm and less than or equal to 590 nm, a dye having a maximum absorption wavelength of greater than 590 nm and less than or equal to 600 nm, and a dye having a maximum absorption wavelength of greater than 600 nm and less than or equal to 610 nm.

The dye having a maximum absorption wavelength of greater than 580 nm and less than or equal to 590 nm may be present in an amount of 0.1 to 3 parts by weight, e.g., 0.1 parts by weight to 2 parts by weight or 0.5 to 1 part by weight, relative to 100 parts by weight of the base resin described below. Within this range, the dye can absorb mixed colors and enhance color reproduction while minimizing loss of luminance. According to an embodiment, the dye having a maximum absorption wavelength of greater than 580 nm and less than or equal to 590 nm may include a sub-PC dye.

The dye having a maximum absorption wavelength of greater than 590 nm and less than or equal to 600 nm may be present in an amount of 0.1 to 3 parts by weight, e.g., 0.1 parts by weight to 2 parts by weight or 0.5 parts by weight to 1 part by weight, relative to 100 parts by weight of the base resin described below. Within this range, the dye can absorb mixed colors and enhance color reproduction while minimizing loss of luminance. According to an embodiment, the dye having a maximum absorption wavelength of greater than 590 nm and less than or equal to 600 nm may include a porphyrin dye.

The dye having a maximum absorption wavelength of greater than 600 nm and less than or equal to 610 nm may be present in an amount of 0.1 parts by weight to 3 parts by weight, e.g., 0.1 parts by weight to 2 parts by weight or 1 part by weight to 1.5 parts by weight, relative to 100 parts by weight of the base resin described below. Within this range, the dye can absorb mixed colors and enhance color reproduction while minimizing loss of luminance. The dye having a maximum absorption wavelength of greater than 600 nm and less than or equal to 610 nm may include a porphyrin dye.

In an embodiment, the second transmittance control layer may include 90 wt % or more, e.g., 95 wt % to 100 wt % or 100 wt %, of a mixture of the dye having a maximum absorption wavelength of 400 nm to 440 nm, the dye having a maximum absorption wavelength of 480 nm to 520 nm, the dye having a maximum absorption wavelength of 570 nm to 610 nm, and the dye having a maximum absorption wavelength of 650 nm to 700 nm, based on the total weight of all dyes contained in the second transmittance control layer

In an embodiment, the maximum absorption wavelength of the dye having a maximum absorption wavelength of 570 nm to 610 nm in the first transmittance control layer may be different from that of the dye having a maximum absorption wavelength of 570 nm to 610 nm in the second transmittance control layer.

The second transmittance control layer may further include a base resin as a matrix for formation of the second transmittance control layer. The base resin may be substantially the same as the base resin of the first transmittance control layer described above.

The second transmittance control layer may further include an additive, e.g., a silane coupling agent, an antioxidant, a tackifier resin, a plasticizer, an antistatic agent, a reworking agent, and the like.

The second transmittance control layer may further include a black dye.

The second transmittance control layer may have a thickness of 0.1 μm to 50 μm, e.g., 1 μm to 30 μm, specifically 1 μm to 10 μm.

### Base Film

The base film may be formed on the transmittance control layer to protect an adhesive layer and the transmittance control layer and to enhance mechanical strength of the optical member. In an embodiment, the base film may be directly formed on the transmittance control layer. Here, “directly formed” means that no other adhesive layer or bonding layer is interposed between the base film and the transmittance control layer.

In an embodiment, the base film may have a light transmittance of 80% or more, e.g., 90% to 99%, at a wavelength of 800 nm. Within this range, the base film can enhance luminous efficacy by not affecting an optical path of external light or internal light transmitted through the optical member. In an embodiment, the base film may have a light transmittance of 1% or less, e.g., 0.1% to 1%, at a wavelength of 380 nm.

The base film may include at least one of an optically clear protective film or an optically clear protective coating layer.

When the base film is of the protective film type, the base film may include a protective film formed of an optically clear resin. The protective film may be formed by melt extrusion of the resin. If necessary, the resin may be further subjected to a stretching process. The resin may include at least one selected from among cellulose ester resins including triacetylcellulose and the like, cyclic polyolefin resins including an amorphous cyclic olefin polymer (COP) and the like, polycarbonate resins, polyester resins including polyethylene terephthalate (PET) and the like, polyethersulfone resins, polysulfone resins, polyamide resins, polyimide resins, non-cyclic polyolefin resins, polyacrylate resins including poly (methyl methacrylate) and the like, polyvinyl alcohol resins, polyvinyl chloride resins, and polyvinylidene chloride resins.

When the base film is of the protective coating layer type, the base film can have good properties in terms of adhesion to an adhesive layer, transparency, mechanical strength, thermal stability, moisture barrier capacity, and durability. In an embodiment, the protective coating layer as the base film may be formed of an actinic radiation-curable resin composition including an actinic radiation-curable compound and a polymerization initiator.

The actinic radiation-curable compound may include at least one selected from among cationic polymerizable curable compounds, radical polymerizable curable compounds, urethane resins, and silicone resins. The cationic polymerizable curable compound may include an epoxy compound containing at least one epoxy group in a molecular structure thereof or an oxetane compound containing at least one oxetane ring in a molecular structure thereof. The radical polymerizable curable compound may include a (meth)acrylic compound containing at least one (meth)acryloyloxy group in a molecular structure thereof.

The base film may have a thickness of 5 μm to 200 μm, e.g., 30 μm to 120 μm, 50 μm to 100 μm (in the case of the protective film type) or 5 μm to 50 μm (in the case of the protective coating layer type). Within this range, the base film can be used in an optical display apparatus.

In an embodiment, the base film does not have a functional coating layer (e.g., an antireflection layer) on one surface thereof.

FIGURE is a cross-sectional view of an optical member according to an embodiment.

Referring to FIGURE, the optical member may include a first transmittance control layer 300, a second transmittance control layer 100, and a base film 200 stacked sequentially. For example, the optical member may further include an adhesive layer and a release film stacked on a lower surface of the first transmittance control layer 300.

In accordance with another aspect of the present disclosure, an optical display apparatus is provided. The optical display apparatus may include the optical member described above. In an embodiment, the optical display apparatus may include a panel for the optical display apparatus and the optical member formed on the panel.

In an embodiment, the optical display does not include a polarizing plate. With the optical member capable of replacing the function of a polarizing plate, the optical display apparatus can prevent damage to a light emitting device, despite the absence of a polarizing plate.

The optical display apparatus may include liquid crystal displays, light emitting device displays, such as organic light emitting device displays, and the like.

Next, the present disclosure will be described in more detail with reference to some examples. However, it should be noted that these examples are provided for illustration only and are not to be construed in any way as limiting the present disclosure.

Details of components used in Examples and Comparative Examples are as follows:
(A) Binder: Poly(methyl methacrylate) (35 wt % in toluene, IF-850, LX company) (B) Dye

### <Dye of the First Transmittance Control Layer>

A sub-PC dye (maximum absorption wavelength: 576 nm, full-width at half maximum: 74 nm, FDG-004, Yamada Chemical Co., Ltd.)

### <Dye of the Second Transmittance Control Layer>

A porphyrin dye (maximum absorption wavelength: 429 nm, full-width at half maximum: 23 nm, VP-40, Daejin Uni-chem Co., Ltd.)
A porphyrin dye (maximum absorption wavelength: 431 nm, full-width at half maximum: 25 nm, FDB-002, Yamada Chemical Co., Ltd.)
An azo dye (maximum absorption wavelength: 493 nm, full-width at half maximum: 21 nm, FDB-022, Yamada Chemical Co., Ltd.)
A xanthene dye (maximum absorption wavelength: 504 nm, full-width at half maximum: 20 nm, FDG-001, Yamada Chemical Co., Ltd.)
A sub-PC dye (maximum absorption wavelength: 581 nm, full-width at half maximum: 17 nm, 581, AMC Corp.)
A porphyrin dye (maximum absorption wavelength: 593 nm, full-width at half maximum: 19 nm, KIS-001, Kyungin Synthetic Co., Ltd.)
A porphyrin dye (maximum absorption wavelength: 604 nm, full-width at half maximum: 24 nm, FDR-001, Yamada Chemical Co., Ltd.)
A squaraine dye (maximum absorption wavelength: 673 nm, full-width at half maximum: 25 nm. BLUE-266, AMC Corp.)

### (C) Black Dye

Black 280 (AMC Corp.)

### (D) UV Absorber

UA3912 (NUV-cut, Orient Chemical Co., Ltd.)

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

Relative to 100 parts by weight of PMMA in terms of solid content, dyes were mixed in amounts shown in Table 1, followed by adding methyl ethyl ketone as a solvent, thereby preparing a composition for a first transmittance control layer (solid content: 13 wt %).

Relative to 100 parts by weight of PMMA in terms of solid content, dyes were mixed in amounts shown in Table 1, followed by adding methyl ethyl ketone as a solvent, thereby preparing a composition for a second transmittance control layer (solid content: 13 wt %).

The composition for the second transmittance control layer was deposited to a predetermined thickness on a lower surface of a base film (triacetylcellulose film, thickness: 40 μm, PG402S, Hyosung Chemical Co., Ltd.), followed by drying at 120° C. for 2 minutes to form a second transmittance control layer (thickness: 2.5 μm) on the lower surface of the base film.

The composition for the first transmittance control layer was deposited to a predetermined thickness on a lower surface of the second transmittance control layer, followed by drying at 120° C. for 2 minutes to form a first transmittance control layer, thereby manufacturing an optical member in which the second transmittance control layer (thickness: 2.5 μm) and the first transmittance control layer (thickness: 2.5 μm) were sequentially formed on the lower surface of the base film.

### Examples 2 to 3

Optical members were manufactured in the same manner as in Example 1 except that the contents of the dyes in the first transmittance control layer and the second transmittance control layer were changed as listed in Table 1.

### Comparative Examples 1 to 3

Optical members were manufactured in the same manner as in Example 1 except that a single dye layer was formed by mixing dyes in amounts shown in Table 2, without division into first and second transmittance control layers.

Each of the optical members manufactured in Examples and Comparative Examples was evaluated as to the properties listed in Table 3 and Table 4. Results are shown in Table 3 and Table 4.

### (1) Initial Light Transmittance of Optical Member

Each of the manufactured optical members was cut to a size of 25 mm×200 mm (width×length) and then attached to a glass plate, thereby preparing a specimen. Light transmittance of the specimen in the wavelength range of 300 nm to 800 nm was measured using a light transmittance measuring instrument (V-650 UV-spectrometer, JASCO Corp.), thereby obtaining light transmittances at wavelengths shown in Table 3 and Table 4.

### (2) Solar Test

Each of the manufactured optical members was cut to a size of 25 mm×200 mm (width×length) and then attached to a glass plate, thereby preparing a specimen. The prepared specimen was placed in a UV chamber and irradiated with 340 nm UV light under the following conditions:

Solar test conditions: A total of 10 cycles of light irradiation (120 hours in total), wherein one cycle was defined as irradiating the specimen with 340 nm UV light at an irradiance of 0.35 W/m² while leaving the specimen at 25° C. for 4 hours and at 63° C. for 8 hours.

Thereafter, the specimen was removed from the UV chamber and then left at room temperature for 30 minutes, followed by obtaining light transmittances in the same manner as in (1). Light transmittance differences ΔT of the specimen before and after the solar test was calculated. A maximum value ΔTmax among ΔT values calculated in the wavelength range of 400 nm to 700 nm was obtained.

### (3) Difference Between Light Transmittances at Different Wavelengths

A difference between light transmittance at a wavelength of 504 nm and light transmittance at a wavelength of 494 nm was calculated.

A difference between light transmittance at a wavelength of 594 nm and light transmittance at a wavelength of 583 nm was calculated.

TABLE 1

| | | | Example 1 | | Example 2 | | Example 3 | |
|---|---|---|---|---|---|---|---|---|
| | | | Second | First | Second | First | Second | First |
| | | | transmittance | transmittance | transmittance | transmittance | transmittance | transmittance |
| | | | control | control | control | control | control | control |
| | λmax | FWHM | layer | layer | layer | layer | layer | layer |
| Second | 429 | 23 | 1.2 | — | 0.4 | — | — | — |
| transmittance | 431 | 25 | — | — | 1 | — | 1.5 | — |
| control layer | | | | | | | | |
| Second | 493 | 21 | 0.7 | — | 0.7 | — | 0.1 | — |
| transmittance | 504 | 20 | 1.1 | — | 0.9 | — | 0.7 | — |
| control layer | | | | | | | | |
| First | 576 | 74 | — | 1.4 | — | 1.3 | — | 1.8 |
| transmittance | | | | | | | | |
| control layer | | | | | | | | |
| Second | 581 | 17 | 1 | — | 0.7 | — | 0.6 | — |
| transmittance | 593 | 19 | 1 | — | 0.9 | — | 0.5 | — |
| control layer | 604 | 24 | 1.3 | — | 1.2 | — | 1 | — |
| Second | 673 | 25 | 1.2 | — | 0.8 | — | 1.5 | — |
| transmittance | | | | | | | | |
| control layer | | | | | | | | |

| | | | | | | |
|---|---|---|---|---|---|---|
| Black dye | — | — | — | — | 2 | — |
| UV absorber | — | 2 | — | 2 | — | — |
| Thickness (μm) | 2.5 | 2.5 | 4 | 4 | 4 | 4 |

TABLE 2

| | | | Comparative | Comparative | Comparative |
|---|---|---|---|---|---|
| | | | Example 1 | Example 2 | Example 3 |
| | | | Single dye | Single dye | Single dye |
| | λmax | FWHM | layer | layer | layer |
| Dyes | 429 | 23 | 1.2 | 0.4 | — |
| | 431 | 25 | — | 1 | 1.4 |
| | 493 | 21 | 0.7 | 0.7 | 0.1 |
| | 504 | 20 | 1.1 | 0.9 | 0.7 |
| | 576 | 74 | 1.4 | 1.3 | 1.8 |
| | 581 | 17 | 1 | 0.7 | 0.6 |
| | 593 | 19 | 1 | 0.9 | 0.5 |
| | 604 | 24 | 1.3 | 1.2 | 1 |
| | 673 | 25 | 1.2 | 0.8 | 1.5 |

| | | | |
|---|---|---|---|
| Black dye | — | — | 2 |
| UV absorber | 2 | 2 | — |
| Thickness (μm) | 2.5 | 4 | 4 |

TABLE 3

| | | Example 1 | | | Example 2 | | | Example 3 | | |
|---|---|---|---|---|---|---|---|---|---|---|
| | | 0 | 120 | | 0 | 120 | | 0 | 120 | |
| | Wavelength | hr | hrs | ΔT | hr | hrs | ΔT | hr | hrs | ΔT |
| BGR | 458 | 55 | 56 | 1 | 58 | 58 | 0 | 59 | 58 | −1 |
| transmittance | 530 | 59 | 60 | 1 | 55 | 55 | 0 | 43 | 44 | 1 |
| (%) | 545 | 49 | 49 | 0 | 42 | 42 | 0 | 32 | 32 | 0 |
| | 630 | 65 | 64 | −1 | 68 | 67 | −1 | 45 | 45 | 0 |
| PEAK | 422 | 32 | 30 | −2 | 19 | 18 | −1 | 9 | 8 | −1 |
| transmittance | 494 | 16 | 19 | 3 | 13 | 15 | 2 | 30 | 30 | 0 |
| (%) | 504 | 16 | 17 | 1 | 14 | 15 | 1 | 19 | 20 | 1 |
| | 583 | 15 | 17 | 2 | 13 | 13 | 0 | 11 | 12 | 1 |
| | 594 | 11 | 12 | 1 | 9 | 10 | 1 | 10 | 11 | 1 |
| | 673 | 49 | 48 | −1 | 59 | 58 | −1 | 42 | 42 | 0 |
| ΔTmax (%) | | — | — | 3.2 | — | — | 1.7 | — | — | 1.5 |
| Difference between | 504-494 | 0 | — | — | 1 | — | — | −10 | — | — |
| light transmittances | 594-583 | −4 | — | — | −4 | — | — | −1 | — | — |
| at different | | | | | | | | | | |
| wavelengths (%) | | | | | | | | | | |

TABLE 4

| | | Comparative | | | Comparative | | | Comparative | | |
|---|---|---|---|---|---|---|---|---|---|---|
| | | Example1 | | | Example2 | | | Example3 | | |
| | | 0 | 120 | | 0 | 120 | | 0 | 120 | |
| | Wavelength | hr | hrs | ΔT | hr | hrs | ΔT | hr | hrs | ΔT |
| BGR | 458 | 54 | 59 | 5 | 58 | 59 | 1 | 59 | 57 | −2 |
| transmittance | 530 | 57 | 64 | 7 | 56 | 56 | 0 | 43 | 46 | 3 |
| (%) | 545 | 48 | 55 | 7 | 43 | 43 | 0 | 32 | 35 | 3 |
| | 630 | 66 | 63 | −3 | 69 | 67 | −2 | 45 | 46 | 1 |
| PEAK | 422 | 31 | 38 | 7 | 20 | 19 | −1 | 9 | 10 | 1 |
| transmittance | 494 | 15 | 26 | 11 | 13 | 18 | 5 | 30 | 35 | 5 |
| (%) | 504 | 15 | 19 | 4 | 14 | 16 | 2 | 20 | 25 | 5 |
| | 583 | 17 | 29 | 12 | 13 | 15 | 2 | 11 | 15 | 4 |
| | 594 | 13 | 19 | 6 | 10 | 10 | 0 | 10 | 13 | 3 |
| | 673 | 48 | 46 | −2 | 57 | 56 | −1 | 42 | 39 | −3 |
| ΔTmax (%) | | — | — | 25 | — | — | 5.1 | — | — | 7.3 |
| Difference | 504-494 | 0 | — | — | 1 | — | — | 1 | — | — |
| between light | 594-583 | −4 | — | — | −3 | — | — | −4 | — | — |
| transmittances at | | | | | | | | | | |
| different | | | | | | | | | | |
| wavelengths (%) | | | | | | | | | | |

As can be seen from Table 3, the optical members of Examples exhibited a low light transmittance variation at a wavelength of 400 nm to 700 nm after long-term exposure to UV light under repeated cycles of temperature change between room temperature and high temperature, thus demonstrating the ability to improve reliability of a display apparatus.

Conversely, as can be seen from Table 4, the optical members of Comparative Examples exhibited a high light transmittance variation at a wavelength of 400 nm to 700 nm after long-term exposure to UV light under repeated cycles of temperature change between room temperature and high temperature.

By way of summation and review, with the trend toward reduction in thickness of optical display apparatuses, development of an optical display apparatus without a polarizing plate (pol-less optical display apparatus) has been ongoing. However, such a pol-less optical display apparatus may be directly exposed to external light, thereby being prone to damage.

Therefore, it is an aspect of the present disclosure to provide an optical member that has a low light transmittance variation at a wavelength of 400 nm to 600 nm even after long-term exposure to UV light under repeated cycles of temperature change between room temperature and high temperature. Another aspect of the present disclosure is to provide a display device including the such an optical member.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An optical member, comprising:
a first transmittance control layer, the first transmittance control layer including a dye having a maximum absorption wavelength of 570 nm to 610 nm;
a second transmittance control layer, the second transmittance control layer including a mixture of a first dye having a maximum absorption wavelength of 400 nm to 440 nm, a second dye having a maximum absorption wavelength of 480 nm to 520 nm, and a third dye having a maximum absorption wavelength of 650 nm to 700 nm; and
a base film, the second transmittance control layer being between the base film and the first transmittance control layer.

2. The optical member as claimed in claim 1, wherein the dye in the first transmittance control layer has a maximum absorption wavelength of 570 nm to 580 nm.

3. The optical member as claimed in claim 1, wherein the dye having the maximum absorption wavelength of 570 nm to 610 nm is present in an amount of 90 wt % or more based on a total weight of all dyes in the first transmittance control layer.

4. The optical member as claimed in claim 1, wherein the second transmittance control layer includes 80 wt % or more of the mixture of the first dye, the second dye, and the third dye, based on a total weight of all dyes in the second transmittance control layer.

5. The optical member as claimed in claim 1, wherein the second transmittance control layer further includes a fourth dye having a maximum absorption wavelength of 570 nm to 610 nm.

6. The optical member as claimed in claim 5, wherein, in the second transmittance control layer, the fourth dye includes at least one of a dye having a maximum absorption wavelength of greater than 580 nm and less than or equal to 590 nm, a dye having a maximum absorption wavelength of greater than 590 nm and less than or equal to 600 nm, and a dye having a maximum absorption wavelength of greater than 600 nm and less than or equal to 610 nm.

7. The optical member as claimed in claim 5, wherein the second transmittance control layer includes 90 wt % or more of a mixture of the first dye, the second dye, the third dye, and the fourth dye, based on a total weight of all dyes in the second transmittance control layer.

8. The optical member as claimed in claim 5, wherein the fourth dye in the second transmittance control layer includes at least one of a sub-PC dye or a porphyrin dye.

9. The optical member as claimed in claim 1, wherein the dye in the first transmittance control layer includes at least one of a sub-PC dye or a porphyrin dye.

10. The optical member as claimed in claim 1, wherein the first dye in the second transmittance control layer includes a porphyrin dye.

11. The optical member as claimed in claim 1, wherein the second dye in the second transmittance control layer includes at least one of an azo dye, a perylene dye, or a xanthene dye.

12. The optical member as claimed in claim 1, wherein the third dye in the second transmittance control layer includes at least one of a squaraine dye or a cyanine dye.

13. The optical member as claimed in claim 1, wherein the first transmittance control layer further includes a UV absorber.

14. The optical member as claimed in claim 1, wherein the first transmittance control layer further includes a base resin.

15. The optical member as claimed in claim 1, wherein the second transmittance control layer further includes a base resin.

16. An optical display apparatus comprising the optical member as claimed in claim 1.

17. The optical display apparatus as claimed in claim 16, wherein the optical display apparatus is free from a polarizer.
